(19) United States
(12) Patent Application Publication
(10) Pub. No.: US 2013/0031024 A1
(43) Pub. Date: Jan. 31, 2013

(54) GENERATING A MEASURE OF INTRANSMISSIBILITY HAZARD FROM EXTREME HETEROGENEOUS DATA

(71) Applicant: Daniel Satchkov, Bayside, NY (US)

(72) Inventor: Daniel Satchkov, Bayside, NY (US)

(73) Assignee: RIXTREMA INC., Bayside, NY (US)

(21) Appl. No.: 13/562,275

(22) Filed: Jul. 30, 2012

Related U.S. Application Data
(60) Provisional application No. 61/513,162, filed on Jul. 29, 2011.

(51) Int. Cl. G06Q 40/06

(52) U.S. Cl. 705/36 R

(57) ABSTRACT

Systems, methods and apparatus are provided through which in some implementations a method of estimating intransmissibility hazard of an item by identifying high and low periods in the item data, and generating an estimated intransmissibility hazard of the item data in reference to the identified high and low performance periods.

### RELATED APPLICATION

This application claims the benefit of U.S. Provisional Application Ser. No. 61/513,162 filed 29 Jul. 2011 under 35 U.S.C. 119(e).

### FIELD

This disclosure relates generally to variable analysis, and more particularly to instability estimates.

### BACKGROUND

Forecasts of any statistic use past observations of some performance parameter of an item. The forecasts can provide through analytical processes more or less importance to some observations, which will change the resulting hazard forecast. One example of assigning more importance to some observations is to use time as the importance criteria, i.e. more recent observations get more (or less) importance. In this way, a hazard forecast will differ from the forecast in which all observations are treated as equally important. Another commonly used hazard forecast simply assigns equal weights to the history of results.

### BRIEF DESCRIPTION

This disclosure is applicable to all methods of forecasting measure of intransmissability hazard of an instrument that use historical data on performance of such instrument(s), most commonly: price, returns, volatility.

In one aspect, a method of determining a measure of an intransmissability hazard in heterogeneous data includes storing an electronically accessible database of the heterogeneous data in a system, the system including at least one computing device with a processor and memory, the memory storing executable instructions that are executable by the processor, identifying a time dimension of the heterogeneous data having distinguishing extreme magnitudes in the electronically accessible database, the distinguishing extreme magnitudes being stored in the memory of the system, identifying commonalities in residuals of the heterogeneous data of the time dimension having the distinguishing extreme magnitudes in the memory of the system that do not exist in the heterogeneous data outside of the time dimension distinguishing extreme magnitudes of the heterogeneous data in the memory of the system, estimating an intransmissibility hazard of the heterogeneous data in the electronically accessible database in the system in reference to the commonalities in the memory of the system.

In a further aspect, a method of determining a measure of intransmissability hazard in heterogeneous data includes storing an electronically accessible repository of the heterogeneous data in a system, the system including at least one computing device with a processor and memory, the memory storing executable instructions that are executable by the processor, entifying an unstable period of the performance measurement of the heterogeneous data of the electronically accessible repository in the system, generating an estimated intransmissibility hazard of the heterogeneous data of the electronically accessible repository of the system in reference to the unstable period.

In another aspect, a system includes a processor, a storage device coupled to the processor, operable to store heterogeneous financial data of an item and analytical rules, an identifier of an extreme-period, the identifier being operable on the processor to receive and identify extreme heterogeneous financial data and an analytical engine that is operable on the processor to receive an analytical rule and the heterogeneous financial data of the extreme-period and operable on the processor to perform the analytical rule on the heterogeneous financial data of the extreme-period using the heterogeneous financial data to generate or yield an estimated intransmissibility hazard.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of an overview of a system to calculate a measure of intransmissability hazard of heterogeneous performance data that changes weighting of past returns, according to an implementation;

FIG. 2 is a flowchart of a method of calculating a measure of intransmissability hazard of an asset by using performance data on past returns, according to an implementation;

FIG. 3 is a flowchart of a method, according to an implementation;

FIG. 4 is a flowchart of a method of identifying unstable periods, according to an implementation;

FIG. 5 is a flowchart of a method of generating estimated intransmissibility hazard in reference to a weighted extreme period, according to an implementation;

FIG. 6 is a flowchart of a method of determining a measure of intransmissability hazard in heterogeneous data;

FIG. 7 is a method of generating the estimated measure of intransmissibility hazard of the heterogeneous data in the electronically accessible database in the system in reference to the weight in the memory of the system; and

FIG. 8 is a block diagram of a hardware and operating environment in which different implementations can be practiced.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

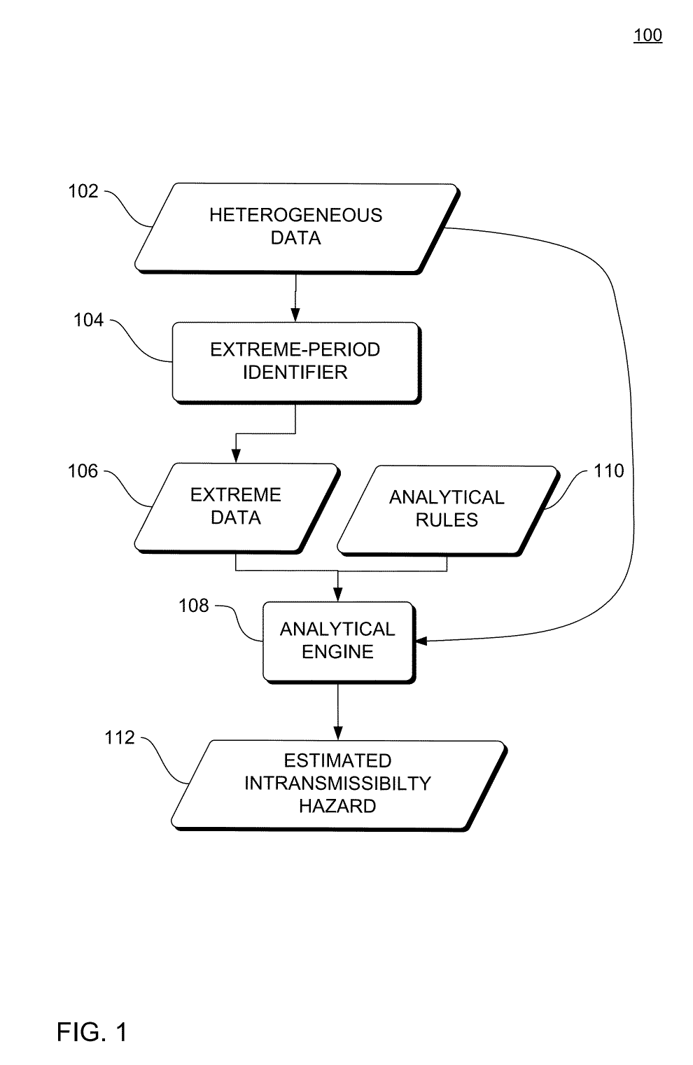

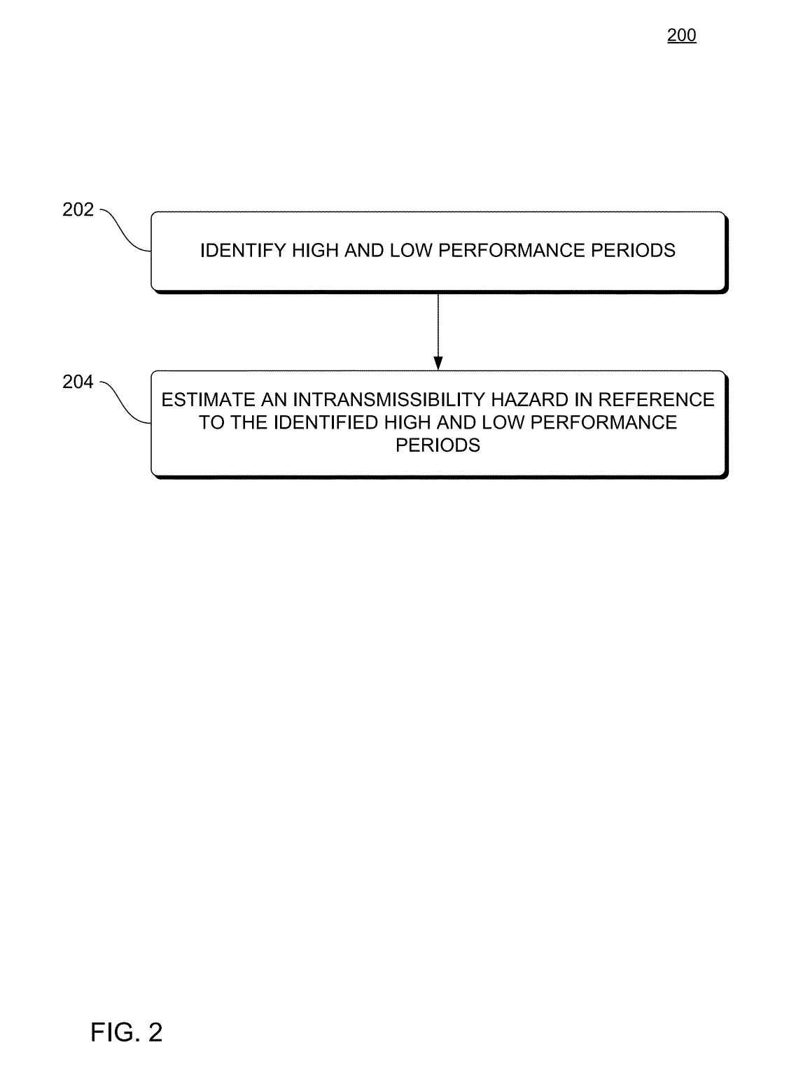

The detailed description is divided into five sections. In the first section, a system level overview is described. In the second section, implementations of methods are described. In the third section, a hardware and the operating environment in conjunction with which implementations may be practiced are described. Finally, in the fourth section, a conclusion of the detailed description is provided. The system 100 in FIG. 1 and methods 200-700 in FIG. 2-7 can be implemented in a multivariate factor risk model.

### System Level Overview

FIG. 1 is a block diagram of an overview of a system 100 to calculate a measure of intransmissability hazard of heterogeneous performance data that changes weighting of past returns, according to an implementation. Intransmissibility hazard is also known as illiquidity risk. Intransmissibility hazard and illiquidity risk is the risk that a given item or asset will not be able to sell. System 100 distinguishes between observations that vary greatly from the mean or median observations that more accurately predicts intransmissibility hazards. System 100 includes heterogeneous financial data 102 that is received by an extreme-period identifier 104. An extreme period is also known as a tail event, extreme events, market crisis, unstable period or period of instability. In the example of the extreme-period identifier 104, the extreme-period identifier 104 identifies the heterogeneous financial data 102 that vary greatly from the mean or median of the heterogeneous financial data 102. The heterogeneous financial data 102 that vary greatly from the mean or median of the heterogeneous financial data 102 is often called ‘extreme’ data. An analytical engine 108 receives the extreme financial data 106, analytical rules 110 and the heterogeneous financial data 102. In general, an engine is a component that performs a very specific and repetitive function in contrast to a component that has many functions. Examples of the analytical rules 110 are principal component analysis (PCA), correlation analysis, spectral analysis, exploratory factor analysis, singular value decomposition, or another statistical method for determining regularities in the heterogeneous financial data 102. The analytical engine 108 performs the analytical rules on the heterogeneous financial data 102 including the extreme financial data 106 to generate or yield an estimated intransmissibility hazard 112. The estimated intransmissibility hazard 112 is a guide or leading indicator of future risk in illiquidity during periods of extreme activity of the item measured by the heterogeneous financial data 102. In some implementations, the analytical engine 108 performs the analytical rules only on the extreme financial data 106 to generate or yield an estimated intransmissibility hazard 112. The estimated intransmissibility hazard 112 can be expressed in a ratio of volume/float for equities and a ratio of bid/ask for fixed income assets.

Illiquidity risk is a crucial aspect in forecasting risk of a financial instrument (e.g. an individual security or an asset class like S&P500), or a group of financial instruments (usually called a “portfolio”). Conventional methods of estimating illiquidity risk analyze a time series of a financial instrument without distinction between normal and extreme periods in the history of returns (or prices) of that instrument, which produces an illiquidity risk estimate that is not accurate during extreme periods. Conventional illiquidity risk models estimate liquidity by plugging the above liquidity variables into mathematical regression equations and then estimating the degree to which the liquidity variables affect each instrument, by pooling the history and creating ‘average’ or ‘weighted average’ coefficients without distinguishing the crisis periods. The inaccuracy comes from the fact that during the extreme periods, “tail” risk factors affect the prices (and returns) of instruments that are not observable when extreme periods are not looked at in isolation. This leaves out the important part of illiquidity risk, namely the illiquidity that appears when markets are in crisis.

While the system 100 is not limited to any particular heterogeneous financial data 102, extreme-period identifier 104, extreme financial data 106, analytical engine 108, analytical rules 110 and estimated intransmissibility hazard 112, for sake of clarity simplified heterogeneous financial data 102, an extreme-period identifier 104, the extreme financial data 106, the analytical engine 108, the analytical rules 110 and the estimated intransmissibility hazard 112 are described.

System 100 in FIG. 1 and methods 200-700 in FIG. 2-7 provide a highly accurate measure of illiquidity risk. “Asset” is used in this disclosure as a synonym for “financial instrument” or a group of financial instruments usually called “a portfolio”. Performance can be expressed in any financial term that shows the historical “behavior” of an asset. Examples: price, price fluctuations (difference in price between certain dates), price growth (between certain dates), returns, volatility, etc. System 100 in FIG. 1 and methods 200-700 in FIG. 2-7 determines illiquidity risk. In order to perform such assignment, system 100 in FIG. 1 and methods 200-700 in FIG. 2-7 can use additional factors beyond the historic performance of an asset (or a group of assets). In some implementations system 100 in FIG. 1 and methods 200-700 in FIG. 2-7 assume that any crisis is driven by the behavior of financial market participants and the design of the financial system and that before the crisis expresses itself in the performance parameter (e.g. corporate financial data or stock performance metrics such as price and volatility) of an asset (the asset that is experiencing, or about to experience, a crisis), the crisis is expressed in the behavior of the participants that can be measured

Additional applications of system 100 in FIG. 1 and methods 200-700 in FIG. 2-7:
forecasting tail illiquidity risk i.e. the risk that an asset will experience a massive drop in a time when the other assets are losing value
improving estimation of the diversification by more accurately computing the systematic and the unsystematic portion of the risks (i.e. estimating the truly independent portion of risk)
improving optimization algorithms by better separating systematic from the unsystematic risk thus making the covariance matrix more accurate.

### Method Implementations

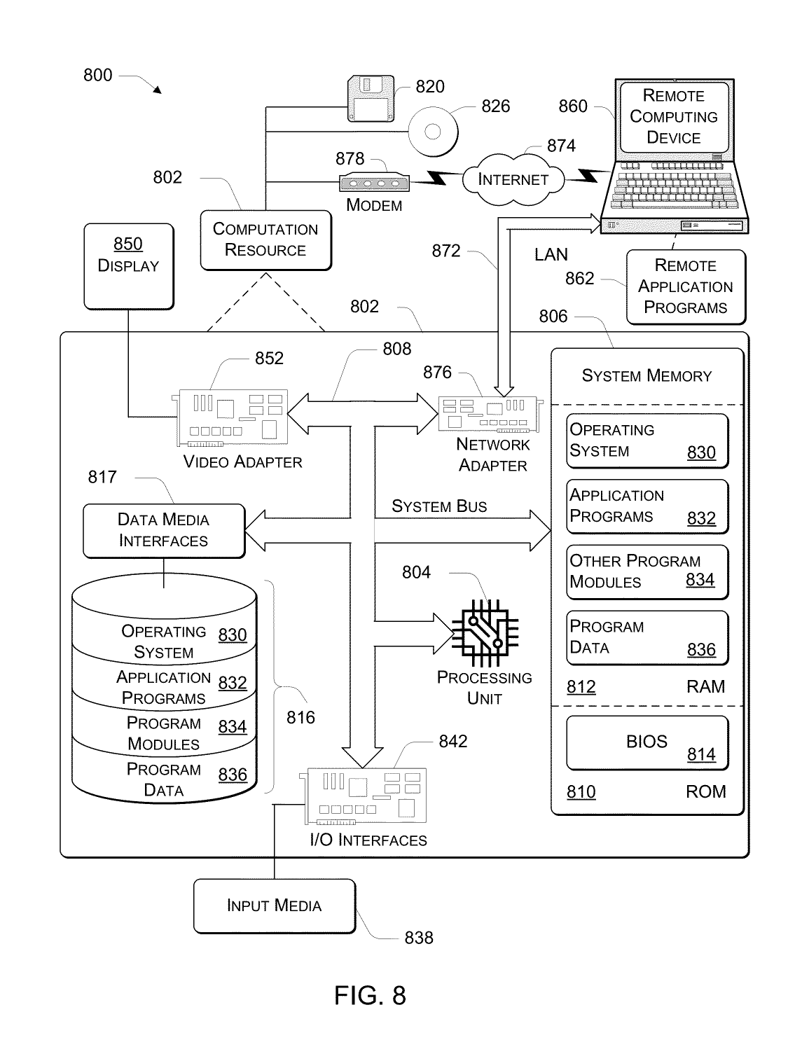

In the previous section, a system level overview of the operation of an implementation is described. In this section, particular methods of implementations are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Methods 200-700 are performed by a program executing on, or performed by firmware or hardware that is a part of, a computer, such as general computer environment 800 in FIG. 8.

FIG. 2 is a flowchart of a method 200 of calculating illiquidity risk of a financial asset, according to an implementation.

Some implementations of method 200 include identifying high and low performance periods in the financial asset performance data, at block 202.

Some implementations of method 200 include generating an estimated intransmissibility hazard of the financial asset performance data in reference to the identified high and low performance periods, at block 204. This disclosure is applicable to all methods of forecasting illiquidity risk of a financial instrument (or a group of financial instruments that is usually called ‘a portfolio’) that use historical data on performance of such instrument(s), most commonly: price, returns, volatility. Method 200 distinguishes between observations that come from “extreme” periods of high and low magnitudes of financial asset performance data. In some implementations, extreme periods for this definition are all observations that are beyond 2 standard deviations from the mean of all observations for which the data is publicly available). When markets are tranquil and realized volatility is low, this leads to a low risk forecast. Thus method 200 does not understate an illiquidity risk before a new “extreme” period of price volatility occurs.

In one example, generating an estimated intransmissibility hazard at block 204, the metric VaR (though any other metric can be used) is implemented. The specific mathematical formulas used below are one technique of generating an estimated intransmissibility hazard. Then an estimated intransmissibility hazard of parametric VaR is introduced. The estimated intransmissibility hazard captures tail risks.

Applied to the factor model risk forecasting, factor models to forecast risk can be implemented using a number of explanatory factors. An assumption is that the factor that are selected explain the returns of the instrument in question. The assumption can be verified by reviewing the properties of the unexplained portion of the return of each security (the part that is not captured by the factors). If the unexplained portion (i.e. the residuals) is independent from security to security, the unexplained portion is a primary indicator that the model performs acceptably. If the unexplained portion is not independent, then an important systemic influence is omitted from the model. One example of a conventional equation is:

Rᵢ=r_{f}+β_{i,1}*F₁+β_{i,2}*F₂+ . . . +β_{N}*F_{N}+εᵢ (1)

where:

Rᵢ=Vector of returns for security i across time

r_{f}=Nominal risk free rate

β_{i,1}=Scalar exposure of security i to factor number 1

Fⱼ=Vector of returns across time for factor j

εᵢ=Vector of error terms for security i

Equation (1) describes the risk of any combination of assets for which the exposures and residual terms are known, in a tail liquidity principal component analysis (PCA) equation as follows:

σ_{P}²=w′*B*C*(w′*B)′+w′*G*w (2)

Where:

B=Matrix of exposures (loadings) of each asset on each factor in the model

C=a Variance/Covariance matrix for all factors

G=a diagonal matrix of residual term variances

Alternatively, PCA in Equation (2) can be replaced with correlation analysis, spectral analysis, exploratory factor analysis or singular value decomposition.

Because matrix G is diagonal, the residual contribution to risk drops quickly with a large number of assets (since weights are below 1 and are squared, making the scalars multiplying the elements of G smaller and smaller as the number of assets increases). Thus, it is clear that errors in the estimate of matrix G are potentially disastrous for the risk management process, since so much is tied to their properties. Yet, some systemic factors that may be masquerading themselves as residual. The preferred method for dealing with this problem is the Principal Component Analysis (PCA) decomposition of the residual to find systematic patterns, which is often called a ‘Hybrid’ approach to factor risk modeling, that recognizes the presence of cross-sectional correlation in the idiosyncratic returns. However, the ‘hybrid’ approach incorrectly assumes that residuals observed are drawn from the homogenous process and consequently no different regimes need to be identified.

Conventional factor modeling is missing significant systematic factors and that even the corrective hybrid risk model procedure that is applied to the residual is not able to uncover the hidden factors. These factors are shown predominantly in extreme environments, as shown in the following test that first applies PCA decomposition to the residual history (assuming that the process is homogenous i.e. the common approach in use) and secondly applies PCA only to the more volatile period residuals (assuming that volatile periods have a different correlation structure that cannot be identified by looking at averages without separating extreme periods). The two methods of scanning the residuals for patterns describe a conventional approach of performing stepwise regressions in order to estimate the beta coefficients of each stock to the factor set in our factor risk model.

Having rᵢⱼ⁽⁰⁾ returns of security jεJ={1, . . . , m} in period iεI={1, . . . , n} and n=808 weekly returns of m=9980 securities between June 1996 and December 2011, in which the securities represent l=48 local markets and all securities are naturally divided into/subsets with indices jεJₖ for each local market k=1 . . . l, so that J=J₁∪J₂∪ . . . ∪Jₗ. On the other hand, the securities represent u=76 industries, so the securities are naturally divided into u subsets with indices jεIₖ. k=1 . . . u, so that J=I₁∪I₂∪ . . . ∪Iᵤ.

The factor model includes the following factors. First, in each local market k=1 . . . l local index Fₖ^{(loc)} is generated by weighting securities returns with capitalization cⱼ, jεJₖ as follows:

$${F}_{ik}^{( loc )} = {\sum }_{j ∈ {J}_{k}} {r}_{ij}^{( 0 )} {ω}_{j} , {ω}_{j} = \frac{{c}_{j}}{{\sum }_{s ∈ {J}_{k}} {c}_{s}} , j ∈ {J}_{k} .$$

Similarly industry indices Fₖ^{(ind)} are generated for each industry k=1 . . . u

$${F}_{ik}^{( ind )} = {\sum }_{j ∈ {I}_{k}} {r}_{ij}^{( 0 )} {ω}_{j} , {ω}_{j} = \frac{{c}_{j}}{{\sum }_{s ∈ {I}_{k}} {c}_{s}} , j ∈ {J}_{k} .$$

Global index F^{(glob)} is generated in a similar fashion by the whole set of securities

$${F}_{i}^{( glob )} = {\sum }_{j ∈ J} {r}_{ij}^{( 0 )} {ω}_{j} , {ω}_{j} = \frac{{c}_{j}}{{\sum }_{s ∈ J} {c}_{s}} , j ∈ J .$$

Additionally, returns of the following factors: oil, gold, size, growth/value and liquidity are denoted by Fᵢ^{(oil)}, Fᵢ^{(gold)}, Fᵢ^{(size)}, Fᵢ^{(gv)}, Fᵢ^{(liq)} correspondingly.

The regression model for each security is generated stepwise as follows. First returns r₋ⱼ⁽⁰⁾ are regressed of the security jεJₖ to the corresponding local factor F₋ₖ^{(loc)} in the form rᵢⱼ⁽⁰⁾=αᵢ+βⱼ^{(loc)}Fᵢⱼ^{(loc)}+rᵢⱼ⁽¹⁾, i=1 . . . n with residuals rᵢⱼ⁽¹⁾. Next, the residuals r⁽¹⁾ are regressed to the oil, gold and global factors as follows

rᵢⱼ⁽¹⁾=βⱼ^{(oil)}Fᵢⱼ^{(oil)}+βⱼ^{(gold)}Fᵢⱼ^{(gold)}+βⱼ^{(glob)}Fᵢⱼ^{(glob)}+rᵢⱼ⁽²⁾, i=1 . . . n

with residuals rᵢⱼ⁽²⁾. Next step involves size, growth/value and liquidity factors:

rᵢⱼ⁽²⁾=βⱼ^{(size)}Fᵢⱼ^{(size)}+βⱼ^{(ge)}Fᵢⱼ^{(ge)}+βⱼ^{(liq)}Fᵢⱼ^{(liq)}+rᵢⱼ⁽³⁾, i=1 . . . n

with residuals rᵢⱼ⁽³⁾. Thereafter industries are involved in two attempts. A first attempt regresses residuals rᵢⱼ⁽³⁾ to all u industries. Then 10 industries with most significant coefficients are selected (there set of their indices is denoted by Uⱼ) and rᵢⱼ⁽³⁾ are regressed to these 10 industries in the form

$${r}_{ij}^{( 3 )} = {\sum }_{k ∈ {U}_{j}} {β}_{kj}^{( ind )} {F}_{ik}^{( ind )} + {r}_{ij}^{( 4 )} ,$$

i=1 . . . n with residuals rᵢⱼ⁽⁴⁾. The standard deviation of the residual that remains after all of the systematic influences were regressed out is the idiosyncratic risk.

In a conventional hybrid technique, as was mentioned above, idiosyncratic risk is addressed by the application of some variation of the so-called ‘hybrid’ method. In one example of such approach, R_{A}⁽⁴⁾ is the complete history of the residuals for all securities within any local equity market having residuals from all periods iεI. Matrix R_{A}⁽⁴⁾ then has the size |I|×|Jₖ| which contains complete residual history for the securities in a given market. Applying PCA to the residual history (which can be applied to some rolling window consistent with the factor model lookback window, for example, 60 months) without distinguishing any regimes. In looking for patterns using only extreme period PCA, an extreme part of the regression model is generated. First for each local index k=1 . . . l 30 extreme periods are defined in which the local index exhibits maximum deviation from it's mean, and the set of such extreme periods is denoted in the local market k by Sₖ. Returns rᵢⱼ⁽⁴⁾ are selected for securities jεJₖ for that local index and for extreme periods iεSₖ, a matrix R⁽⁴⁾ of size |S|×|Jₖ| is formed from those returns. PCA is applied to the residual history of only the selected extreme periods into the matrix R⁽⁴⁾.

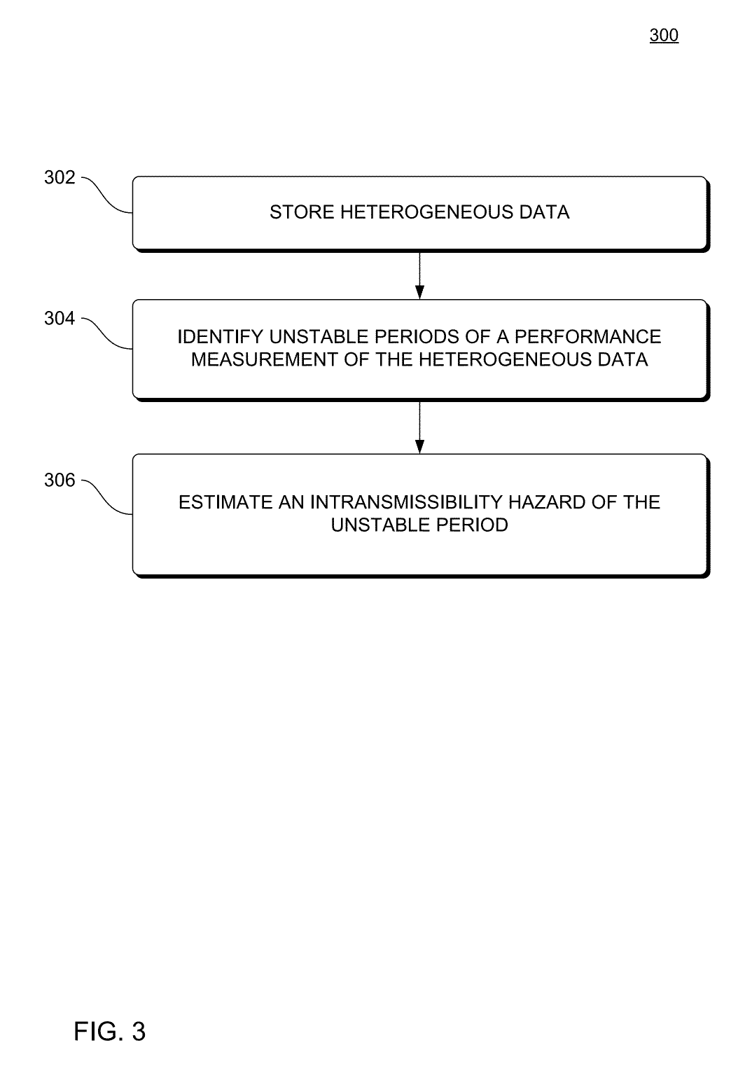

FIG. 3 is a flowchart of a method 300, according to an implementation. Method 300 determines a measure of intransmissability hazard in financial data, or other heterogeneous data. The financial data includes performance measurement data that has a time dimension.

Some implementations of method 300 include storing an electronically accessible repository of the financial data in a system, at block 302. The system includes at least one computing device with a processor and memory, such as shown in FIG. 8. The memory stores executable instructions that are executable by the processor.

Some implementations of method 300 include identifying unstable periods of the performance measurement of the financial data of the electronically accessible repository in the system, at block 304.

Some implementations of method 300 include estimating an intransmissibility hazard of the financial data of the electronically accessible repository of the system in reference to the weight, at block 306.

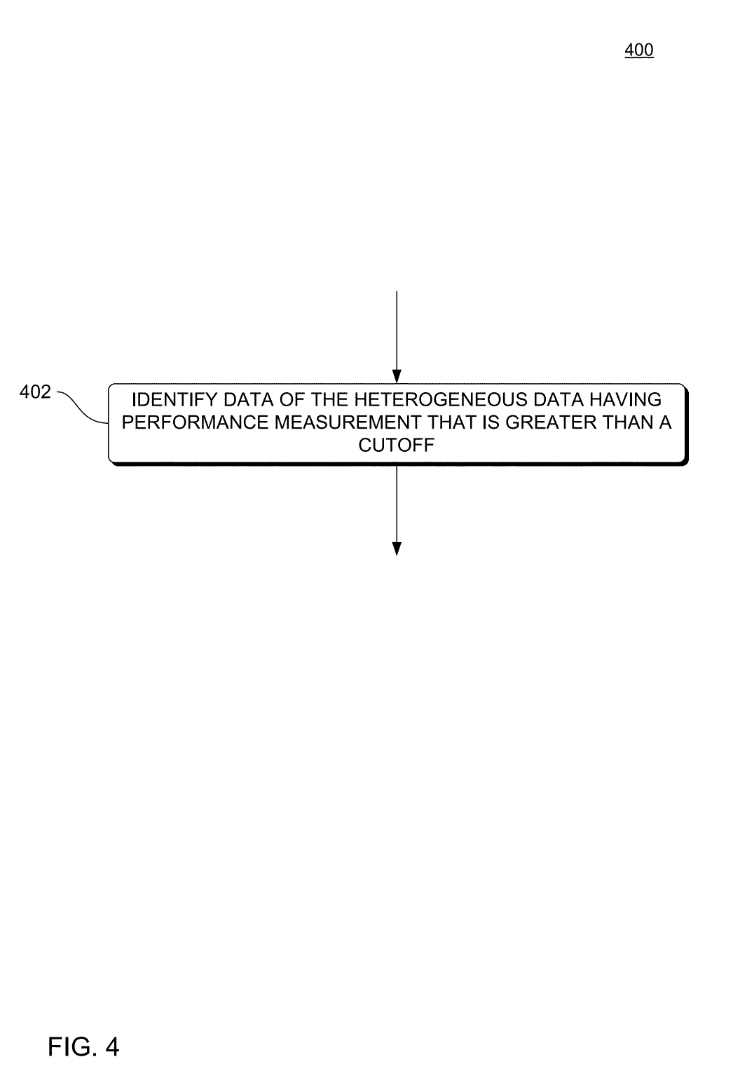

FIG. 4 is a flowchart of a method 400 of identifying unstable periods 400, according to an implementation. Method 400 is one example of identifying unstable periods, at block 304 of method 300 in FIG. 3.

Some implementations of method 400 include identifying data of the financial data that has performance measurement that is greater than a predetermined cutoff value, at block 402. In some implementations the predetermined cutoff value is 2 standard deviations.

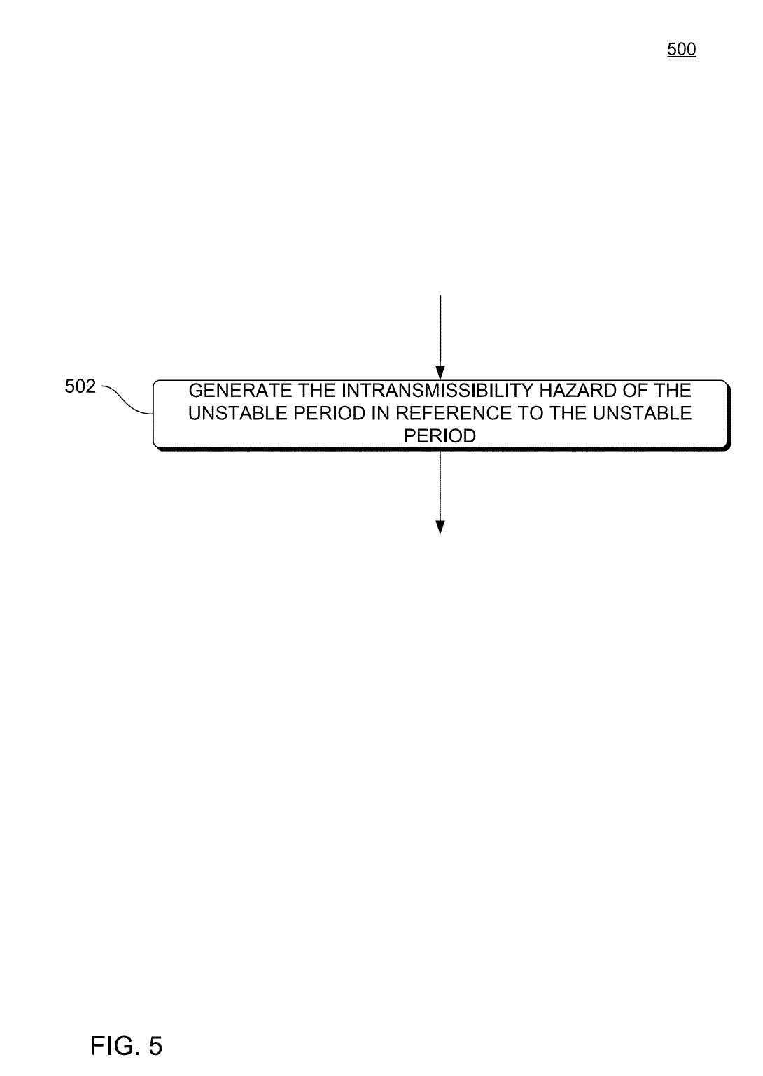

FIG. 5 is a flowchart of a method 500 of generating instability estimator in reference to a weighted extreme period, according to an implementation. Some implementations of method 500 include generating the intransmissibility hazard in reference to the financial data of the time dimension that has the unstable period(s) in the memory of the system at the identified extreme period of an asset, at block 502.

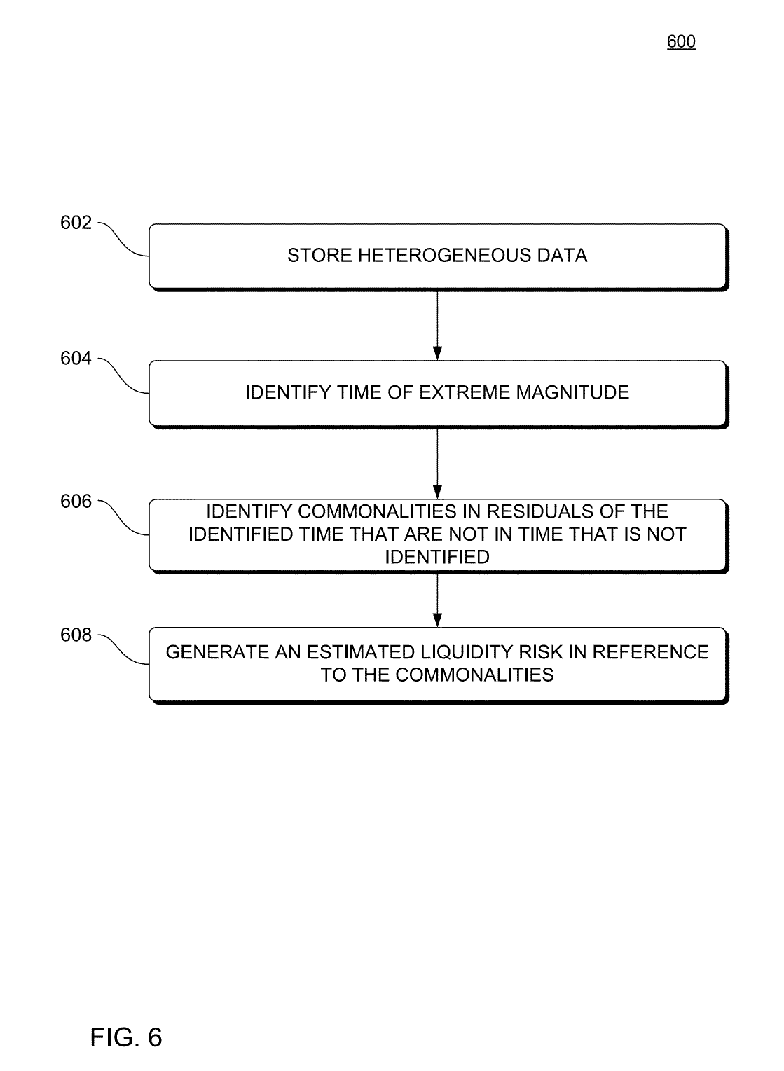

FIG. 6 is a flowchart of a method 600 of determining illiquidity risk in heterogeneous data. The heterogeneous data includes a time dimension and a magnitude dimension. Some implementations of method 600 include storing an electronically accessible database of the heterogeneous data in a system. The system includes at least one computing device with a processor and memory. The memory stores executable instructions that are executable by the processor, at block 602. Some implementations of method 600 include identifying a time dimension having distinguishing extreme magnitudes of the heterogeneous data in the electronically accessible database. The magnitude dimension is associated with the time dimension as two dimensions in a two-dimensional Cartesian graph. The distinguished extreme magnitudes being stored in the memory of the system, at block 604. In some implementations of identifying the time dimension having distinguishing extreme magnitudes includes identifying data of the heterogeneous data that has the magnitude dimension that is greater than a cutoff. In some implementations the cutoff is 2 standard deviations of the heterogeneous data of the electronically accessible database of the system.

In some implementations, the magnitude dimension is a performance parameter. Some implementations of method 600 include identifying commonalities in residuals of the heterogeneous data of the time dimension having the distinguishing extreme magnitudes that do not exist in the heterogeneous data outside of the time dimension of the extreme magnitudes of the heterogeneous data, at block 606.

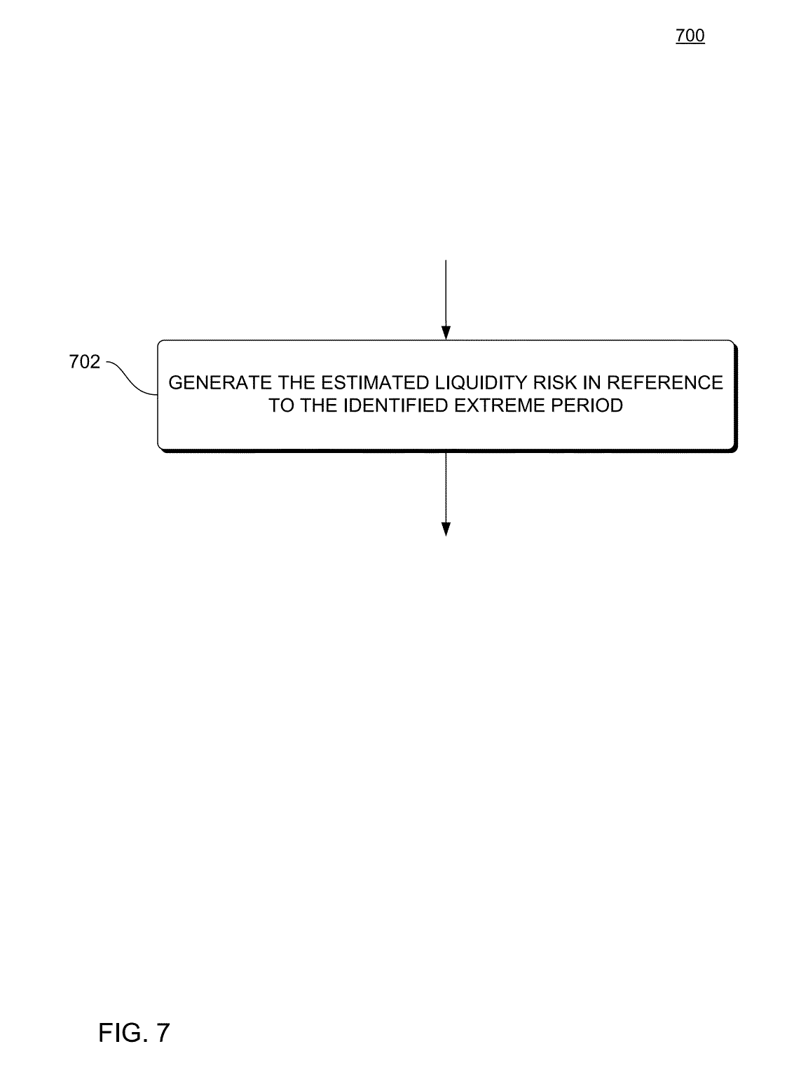

Some implementations of method 600 include generating an estimated illiquidity risk of the heterogeneous data in reference to the identified commonalities in the memory of the system, at block 608. One implementation of generating the estimated illiquidity risk is method 700 in FIG. 7.

FIG. 7 is a method 700 of generating the illiquidity estimated risk of the heterogeneous data in the electronically accessible database in the system in reference to the weight in the memory of the system. Method 700 is one example of generating an estimated risk at block 608 in FIG. 6. Method 700 includes generating the estimated illiquidity risk, at block 702.

In some implementations, methods 200-700 are implemented as a computer data signal embodied in a carrier wave, that represents a sequence of instructions which, when executed by a processor, such as processing units 804 in FIG. 8, cause the processor to perform the respective method. In other implementations, methods 200-700 are implemented as a computer-accessible medium having executable instructions capable of directing a processor, such as processing units 804 in FIG. 8, to perform the respective method. In varying implementations, the medium is a magnetic medium, an electronic medium, or an optical medium.

### Hardware and Operating Environment

FIG. 8 is a block diagram of a hardware and operating environment 800 in which different implementations can be practiced. The description of FIG. 8 provides an overview of computer hardware and a suitable computing environment in conjunction with which some implementations can be implemented. Implementations are described in terms of a computer executing computer-executable instructions. However, some implementations can be implemented entirely in computer hardware in which the computer-executable instructions are implemented in read-only memory. Some implementations can also be implemented in client/server computing environments where remote devices that perform tasks are linked through a communications network. Program modules can be located in both local and remote memory storage devices in a distributed computing environment.

FIG. 8 illustrates an example of a general computer environment 800, in accordance with an implementation of the disclosed subject matter. The general computer environment 800 includes a computation device 802 capable of implementing the processes described herein. It will be appreciated that other devices can alternatively include more components, or fewer components, than those illustrated in FIG. 8.

The illustrated operating environment 800 is only one example of a suitable operating environment, and the example described with reference to FIG. 8 is not intended to suggest any limitation as to the scope of use or functionality of the implementations of this disclosure. Other well-known computing systems, environments, and/or configurations can be suitable for implementation and/or application of the subject matter disclosed herein.

The computation device 802 includes one or more processors or processing units 804, a system memory 806, and a bus 808 that couples various system components including the system memory 806 to processor(s) 804 and other elements in the environment 800. The bus 808 represents one or more of any of several types of bus structures, including a memory bus or memory controller, a peripheral bus, an accelerated graphics port and a processor or local bus using any of a variety of bus architectures, and can be compatible with SCSI (small computer system interconnect), or other conventional bus architectures and protocols.

The system memory 806 includes nonvolatile read-only memory (ROM) 810 and random access memory (RAM) 812, which can or can not include volatile memory elements. A basic input/output system (BIOS) 814, containing the elementary routines that help to transfer information between elements within computation device 802 and with external items, typically invoked into operating memory during start-up, is stored in ROM 810.

The computation device 802 further can include a non-volatile read/write memory 816, represented in FIG. 8 as a hard disk drive, coupled to bus 808 via a data media interface 817 (e.g., a SCSI, ATA, or other type of interface); a magnetic disk drive (not shown) for reading from, and/or writing to, a removable magnetic disk 820 and an optical disk drive (not shown) for reading from, and/or writing to, a removable optical disk 826 such as a CD, DVD, or other optical media.

The non-volatile read/write memory 816 and associated computer-readable media provide nonvolatile storage of computer-readable instructions, data structures, program modules and other data for the computation device 802. Although the exemplary environment 800 is described herein as employing a non-volatile read/write memory 816, a removable magnetic disk 820 and a removable optical disk 826, it will be appreciated by those skilled in the art that other types of computer-readable media which can store data that is accessible by a computer, such as magnetic cassettes, FLASH memory cards, random access memories (RAMs), read only memories (ROM), and the like, can also be used in the exemplary operating environment.

A number of program modules can be stored via the non-volatile read/write memory 816, magnetic disk 820, optical disk 826, ROM 810, or RAM 812, including an operating system 830, one or more application programs 832, other program modules 834 and program data 836. Examples of computer operating systems conventionally employed for some types of three-dimensional and/or two-dimensional medical image data include the NUCLEUS® operating system, the LINUX® operating system, and others, for example, providing capability for supporting application programs 832 using, for example, code modules written in the C++® computer programming language.

A user can enter commands and information into computation device 802 through input devices such as input media 838 (e.g., keyboard/keypad, tactile input or pointing device, mouse, foot-operated switching apparatus, joystick, touchscreen or touchpad, microphone, antenna etc.). Such input devices 838 are coupled to the processing unit 804 through a conventional input/output interface 842 that is, in turn, coupled to the system bus. A monitor 850 or other type of display device is also coupled to the system bus 808 via an interface, such as a video adapter 852.

The computation device 802 can include capability for operating in a networked environment using logical connections to one or more remote computers, such as a remote computer 860. The remote computer 860 can be a personal computer, a server, a router, a network PC, a peer device or other common network node, and typically includes many or all of the elements described above relative to the computation device 802. In a networked environment, program modules depicted relative to the computation device 802, or portions thereof, can be stored in a remote memory storage device such as can be associated with the remote computer 860. By way of example, remote application programs 862 reside on a memory device of the remote computer 860. The logical connections represented in FIG. 8 can include interface capabilities a storage area network (SAN, not illustrated in FIG. 8), local area network (LAN) 872 and/or a wide area network (WAN) 874, but can also include other networks.

Such networking environments are commonplace in modern computer systems, and in association with intranets and the Internet. In certain implementations, the computation device 802 executes an Internet Web browser program (which can optionally be integrated into the operating system 830), such as the “Internet Explorer®” Web browser manufactured and distributed by the Microsoft Corporation of Redmond, Wash.

When used in a LAN-coupled environment, the computation device 802 communicates with or through the local area network 872 via a network interface or adapter 876. When used in a WAN-coupled environment, the computation device 802 typically includes interfaces, such as a modem 878, or other apparatus, for establishing communications with or through the WAN 874, such as the Internet. The modem 878, which can be internal or external, is coupled to the system bus 808 via a serial port interface.

In a networked environment, program modules depicted relative to the computation device 802, or portions thereof, can be stored in remote memory apparatus. It will be appreciated that the network connections shown are exemplary, and other means of establishing a communications link between various computer systems and elements can be used.

A user of a computer can operate in a networked environment 800 using logical connections to one or more remote computers, such as a remote computer 860, which can be a personal computer, a server, a router, a network PC, a peer device or other common network node. Typically, a remote computer 860 includes many or all of the elements described above relative to the computer 800 of FIG. 8.

The computation device 802 typically includes at least some form of computer-readable media. Computer-readable media can be any available media that can be accessed by the computation device 802. By way of example, and not limitation, computer-readable media can comprise computer storage media and communication media.

Computer storage media include volatile and nonvolatile, removable and non-removable media, implemented in any method or technology for storage of information, such as computer-readable instructions, data structures, program modules or other data. The term “computer storage media” includes, but is not limited to, RAM, ROM, EEPROM, FLASH memory or other memory technology, CD, DVD, or other optical storage, magnetic cassettes, magnetic tape, magnetic disk storage or other magnetic storage devices, or any other media which can be used to store computer-intelligible information and which can be accessed by the computation device 802.

Communication media typically embodies computer-readable instructions, data structures, program modules or other data, represented via, and determinable from, a modulated data signal, such as a carrier wave or other transport mechanism, and includes any information delivery media. The term “modulated data signal” means a signal that has one or more of its characteristics set or changed in such a manner as to encode information in the signal in a fashion amenable to computer interpretation.

By way of example, and not limitation, communication media include wired media, such as wired network or direct-wired connections, and wireless media, such as acoustic, RF, infrared and other wireless media. The scope of the term computer-readable media includes combinations of any of the above.

System 100 components can be embodied as computer hardware circuitry or as a computer-readable program, or a combination of both. In another implementation, system 100 is implemented in an application service provider (ASP) system.

More specifically, in the computer-readable program implementation, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in general computer environment 800 in FIG. 8, or on at least as many computers as there are components.

Calculating a risk of a financial asset performance data that changes weighting of past returns is described. A technical effect of the accurate instability estimates is precise estimates of risk of the financial asset. Although specific implementations have been illustrated and described herein, it will be appreciated by those of ordinary skill in the art that any arrangement which is calculated to achieve the same purpose may be substituted for the specific implementations shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future communication devices, different file systems, and new data types.

### CONCLUSION

The terminology used in this application is meant to include all object-oriented, database and communication environments and alternate technologies which provide the same functionality as described herein.

1. A method of determining a measure of an intransmissability hazard in heterogeneous data, the heterogeneous data including a time dimension and a magnitude dimension, the method comprising:
storing an electronically accessible database of the heterogeneous data in a system, the system including at least one computing device with a processor and memory, the memory storing executable instructions that are executable by the processor;
identifying a time dimension of the heterogeneous data having distinguishing extreme magnitudes in the electronically accessible database, the distinguishing extreme magnitudes being stored in the memory of the system;
identifying commonalities in residuals of the heterogeneous data of the time dimension having the distinguishing extreme magnitudes in the memory of the system that do not exist in the heterogeneous data outside of the time dimension distinguishing extreme magnitudes of the heterogeneous data in the memory of the system; and
estimating an intransmissibility hazard of the heterogeneous data in the electronically accessible database in the system in reference to the commonalities in the memory of the system.

2. The method of claim 1, wherein the magnitude further comprises:
a performance parameter comprising at least one of corporate financial data and stock performance metrics.

3. The method of claim 1, wherein the identifying the time dimension having distinguishing extreme magnitudes further comprises:
identifying data of the heterogeneous data having the magnitude that is greater than a predetermined cutoff value.

4. The method of claim 3, wherein the predetermined cutoff value further comprises:
2 standard deviations of the heterogeneous data of the electronically accessible database of the system.

5. The method of claim 1, wherein identifying the commonalities further comprises:

6. The method of claim 1, wherein estimating the intransmissibility hazard of the heterogeneous data in the electronically accessible database in the system in reference to the commonalities in the memory of the system further comprises:
generating the estimated intransmissibility hazard in reference to the commonalities of the heterogeneous data of the time dimension having the distinguishing extreme magnitudes in the memory of the system based on the identified extreme-period of an item.

7. A method of determining a measure of intransmissability hazard in heterogeneous data, the heterogeneous data including a time dimension and a performance measurement, the method comprising:
storing an electronically accessible repository of the heterogeneous data in a system, the system including at least one computing device with a processor and memory, the memory storing executable instructions that are executable by the processor;
identifying an unstable period of the performance measurement of the heterogeneous data of the electronically accessible repository in the system;
generating an estimated intransmissibility hazard of the heterogeneous data of the electronically accessible repository of the system in reference to the unstable period.

8. The method of claim 7, wherein the identifying further comprises:
identifying data of the heterogeneous data having performance measurement that is greater than a cutoff.

9. The method of claim 8, wherein the cutoff further comprises:
2 standard deviations of the heterogeneous data.

10. The method of claim 7, wherein.

11. The method of claim 7, wherein generating the estimated intransmissibility hazard of the heterogeneous data in the electronically accessible repository in the system in reference to the unstable period in the memory of the system further comprises:
generating the estimated intransmissibility hazard in reference to the heterogeneous data in the unstable periods in the memory of the system based on the identified unstable period of an item.

12. The method of claim 7, wherein the heterogeneous data further comprises:
financial data.

13. A system comprising:
a processor;
a storage device coupled to the processor, operable to store heterogeneous financial data of an item and analytical rules;
an identifier of an extreme-period, the identifier being operable on the processor to receive and identify extreme heterogeneous financial data; and
an analytical engine that is operable on the processor to receive an analytical rule and the heterogeneous financial data of the extreme-period and operable on the processor to perform the analytical rule on the heterogeneous financial data of the extreme-period using the heterogeneous financial data to generate or yield an estimated intransmissibility hazard.

14. The system of claim 13, wherein the heterogeneous financial data further comprises:
securities data.

15. The system of claim 13, wherein the analytical rules further comprise:
value-at-risk analytical rules.

16. The system of claim 13, wherein the analytical engine further comprises:
a leading indicator of future periods of extreme activity of the item measured by the heterogeneous financial data.

17. The system of claim 13, wherein identify further comprises:
identify a subset of the heterogeneous financial data having performance measurement that is greater than a cutoff.

18. The system of claim 17, wherein the cutoff further comprises:
2 standard deviations of the heterogeneous financial data.

19. The system of claim 13, wherein the analytical engine is operable to perform the analytical rule on only the extreme-period of the heterogeneous financial data.

20. The system of claim 13, wherein generating the estimated intransmissibility hazard of the heterogeneous financial data in the storage device in reference to the extreme-period further comprises:
generating the estimated intransmissibility hazard in reference to the heterogeneous financial data in the storage device and the identified extreme-period of the item.
